(19) United States
(12) Patent Application Publication
(10) Pub. No.: US 2006/0037645 A1
(43) Pub. Date: Feb. 23, 2006

(54) Hydraulic power steering valve housing

(75) Inventors: Torsten Boldt, Neuss (DE); Markus Lingemann, Bochum (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: TRW Automotive GmbH

(21) Appl. No.: 11/206,594

(22) Filed: Aug. 18, 2005

(30) Foreign Application Priority Data
Aug. 18, 2004 (DE) 20 2004 012 963.9

(51) Int. Cl. G05D 7/03

(52) U.S. Cl. 137/494

(57) ABSTRACT

A hydraulic power steering valve housing includes a supply line to a power steering valve, and a return flow line. A valve is provided which acts on the return flow line so as to change a cross section of the return flow line.

### CROSS-REFERENCE TO RELATED APPLICATIONS

This application claims priority to German Application No. 20 2004 012 963.9 filed Aug. 18, 2004, the disclosures of which are incorporated herein by reference.

The invention relates to a hydraulic power steering valve housing including a supply line to a power steering valve, and a return flow line.

### BACKGROUND OF THE INVENTION

Such power steering valve housings are generally known and used in power steering systems of motor vehicles, with the power steering valve serving to control the hydraulic servo motor associated with the power steering system. In this arrangement the power steering valve is disposed in a housing also known as a valve tower and connected via the supply line to an oil pump and via the return flow line to an oil tank communicating with the oil pump. Whilst an operating pressure of about 100 bars exists in the supply line, the return flow line is solely under atmospheric pressure. This may already lead with minor pressure variations to cavitation in the return flow line on the one hand and on the other hand to vibrations in the liquid column formed in the power steering valve, these vibrations conveying themselves to the entire power steering valve housing and the steering cylinder, which in turn results in an unnecessary stress of the components and an undesirable development of noise.

Therefore, it is a feature of the present invention to provide a power steering valve housing, with which cavitation in the return flow line and system vibrations are prevented.

### BRIEF SUMMARY OF THE INVENTION

In accordance with the invention there is provided in a power steering valve housing of the aforementioned kind a valve by means of which the cross section of the return flow line may be changed. In this manner the return flow line pressure may be increased by up to 5 bars, whereby cavitation in the return flow line is prevented. Undesirable vibrations are likewise dampened; the steering cylinder is quasi “clamped”. In order to be able to make available the same supporting power in the servo cylinder in spite of the return flow line pressure being increased, preferably the supply line pressure is correspondingly increased; thus, the difference in pressure between the supply line and the return flow line remains constant.

Preferably, there is provided a branch channel which is disposed between the return flow line and the supply line. This interconnection enables a control of the return flow line pressure dependent on the supply line pressure.

In accordance with a preferred embodiment the valve comprises an adjusting piston which is disposed in the branch channel and advantageously embodied such that it seals the return flow line against the supply line. Thus, the adjusting piston prevents a hydraulic short circuit between the supply line and the return flow line, which could impair the manner of operation of the power steering valve.

In this arrangement the cross section of the return flow line may be changed by displacing the adjusting piston, which results in a simple and effective dynamic control of the return flow line pressure.

In accordance with a preferred embodiment the valve comprises a stop shoulder which is disposed at the end of the branch channel situated at the return flow line side and which serves as a stop for the adjusting piston. In this manner the cross section of the return flow line and thus the return flow line pressure may be changed within an exactly predetermined range, the danger of a complete sealing of the return flow line being avoided.

The valve preferably comprises a return element enabling a return of the adjusting piston when the supply line pressure drops and thus a corresponding adjustment of the return flow line pressure.

In accordance with a preferred embodiment the return element is an elastic hose advantageously disposed along the return flow line. This elastic hose does not only serve for rebounding the adjusting piston, but additionally also regulates the flow cross section of the return flow line.

Preferably, the valve comprises a second ring disposed at the end of the return flow line situated at the steering valve side. This ring provides for a constant oil inflow cross section into the return flow line.

In accordance with a further preferred embodiment the return element is a spring which is advantageously disposed around the adjusting piston in the branch channel. Thus, a simple, robust and cost-effective return mechanism is created.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a sectional view of a power steering valve housing according to a first embodiment of the invention; and

FIG. 2 shows a sectional view of a power steering valve housing according to a second embodiment of the invention.

### DETAILED DESCRIPTION OF THE INVENTION

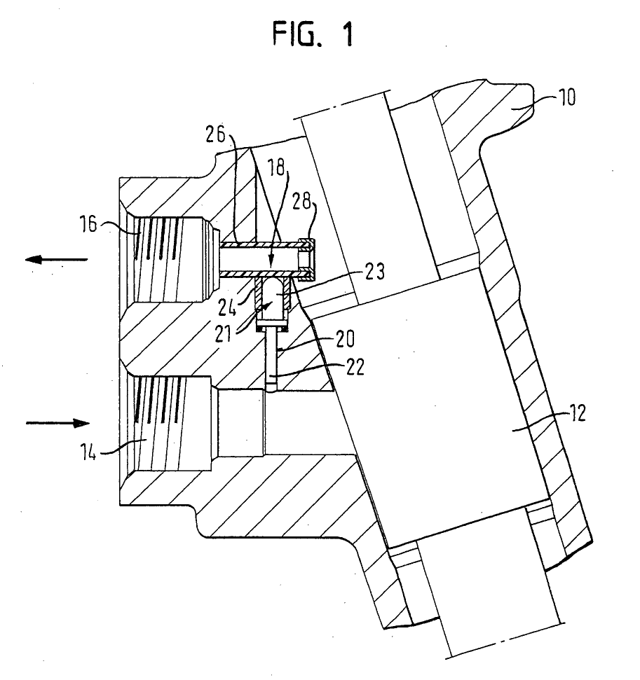

In FIG. 1, there is shown a power steering valve housing 10 according to a first embodiment. It is occasionally also referred to as a valve tower and receives a power steering valve 12 as indicated only schematically in FIG. 1. The power steering valve housing 10 comprises a supply line 14 and a return flow line 16. The supply line 14 serves in operation to connect the power steering valve 12 to an oil pump not shown, and the return flow line 16 connects the power steering valve 12 to an oil tank which is not shown either and which in turn communicates with the oil pump.

There are further provided a valve 18 and a branch channel 20 disposed between the return flow line 16 and the supply line 14. In the branch channel 20 there is disposed an adjusting piston 21 of the valve 18 which comprises at its end situated at the supply line side a pressure sensor section 22 and at its end situated at the return flow line side a shutoff section 23. In this arrangement the pressure sensor section 22 is designed such that it seals the return flow line 16 against the supply line 14. The valve 18 further comprises a stop shoulder in the form of a first ring 24 which is disposed at the end of the branch channel 20 situated at the return flow line side and which serves as a stop for the adjusting piston 21.

Moreover, there is provided a return element in the form of an elastic hose 26 which is disposed along the return flow line 16 and encompasses a second ring 28 disposed at the end of the return flow line 16 situated at the steering valve side. Optionally, the valve 18 may comprise an additional return spring (not shown) which is arranged about the adjusting piston 21 in the branch channel 20.

When the power steering valve housing 10 is in operation, there exists in the supply line 14 a pressure of about 100 bars, partly of up to 130 bars, which clearly exceeds the pressure in the return flow line 16. On account of this difference in pressure the adjusting piston 21 is shifted in the branch channel 20 towards the return flow line 16 (upwards in the Figure), with the adjusting piston 21 sealing at the first ring 24 on account of its width and length and preventing a hydraulic short circuit between the supply line 14 and the return flow line 16.

By raising the adjusting piston 21 the elastic hose 26 is compressed, whereby the effective cross section of the return flow line is reduced, which results in a pressure rise in the return flow line 16. This pressure rise is dependent on the supply line pressure, the volume flow, the piston surface of the adjusting piston 21 at the supply line pressure side, and the spring rigidity of the elastic hose 26.

In this arrangement the first ring 24 serves the function of limiting the stroke of the adjusting piston 21 and, when an optional return spring is used, additionally that of a buttress for the spring. The second ring 28 provides for a constant oil inflow cross section into the return flow line 16.

If the pressure in the supply line 14 drops, the elastic hose 26 or the optional return spring serve for rebounding the adjusting piston 21 and thus for a dynamic adaptation of the return flow line pressure.

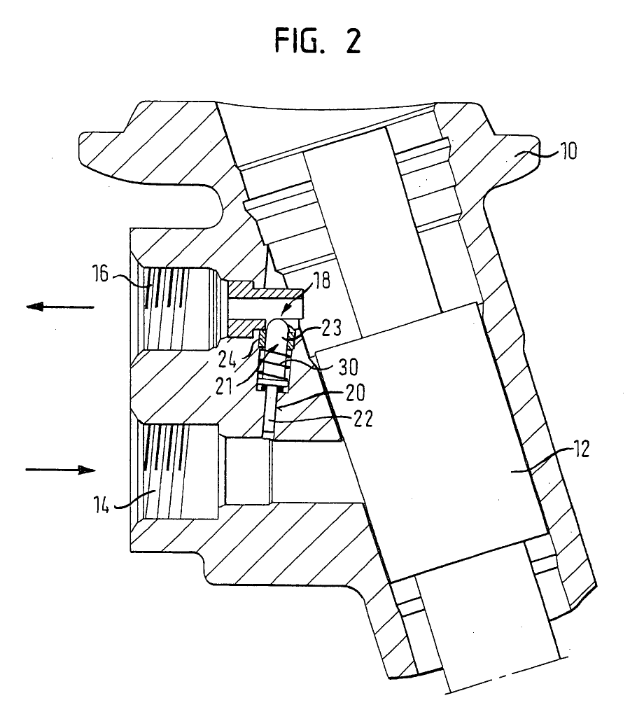

The second embodiment of a power steering valve housing 10 shown in FIG. 2 dispenses with the elastic hose 26 and consequently with the second ring 28 and comprises instead as a return element the return spring 30 which has already been mentioned and which is disposed about the adjusting piston 21 in the branch channel 20. In this arrangement the first ring 24 again serves for the limitation of the piston stroke and as a buttress for the spring 30.

In other respects, the power steering valve housing of FIG. 2 is identical in design and function to the one shown in FIG. 1.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A hydraulic power steering valve housing including a supply line to a power steering valve, and a return flow line, wherein a valve is provided which acts on said return flow line so as to change a cross section of said return flow line.

2. The power steering valve housing of claim 1 wherein a branch channel is provided which is arranged between said return flow line and said supply line.

3. The power steering valve housing of claim 2 wherein said valve comprises an adjusting piston which is arranged in said branch channel.

4. The power steering valve housing of claim 3 wherein said adjusting piston has a first end associated with said supply line and a second end associated with said return flow line, said first end being formed as a pressure sensor section and said second end being formed as a shutoff section.

5. The power steering valve housing of claim 3 wherein said adjusting piston is designed such that it seals said return flow line against said supply line.

6. The power steering valve housing of claim 3 wherein a cross section of said return flow line is changed by displacing said adjusting piston.

7. The power steering valve housing of claim 6 wherein said adjusting piston is displaced as a function of a pressure in said supply line.

8. The power steering valve housing of claim 3 wherein said valve comprises a stop shoulder which is arranged at an end of said branch channel situated at a side of said return flow line and which serves as a stop for said adjusting piston.

9. The power steering valve housing of claim 1 wherein said valve comprises a return element.

10. The power steering valve housing of claim 9 wherein said return element is an elastic hose.

11. The power steering valve housing of claim 10 wherein said elastic hose is arranged along said return flow line.

12. The power steering valve housing of claim 11 wherein said valve comprises a ring which is arranged at an end of said return flow line situated at a side of said steering valve.

13. The power steering valve housing of claim 9 wherein said return element is a spring.

14. The power steering valve housing of claim 13 wherein said spring is arranged about said adjusting piston in said branch channel.
